(19) United States
(12) Patent Application Publication
(10) Pub. No.: US 2002/0123955 A1
(43) Pub. Date: Sep. 5, 2002

(54) System and method for collectibles

(76) Inventors: Greg Andreski, Dover, NJ (US); Robert Cistaro, Little Falls, NJ (US); Brian Alter, Succasunna, NJ (US)

Correspondence Address: Philip M. Weiss, Weiss & Weiss, 500 Old Country Road, Suite 305, Garden City, NY, 11530, US

(21) Appl. No.: 09/752,596

(22) Filed: Dec. 28, 2000

(51) Int. Cl. G06F 17/60

(52) U.S. Cl. 705/37; 705/27; 705/14

(57) ABSTRACT

The present invention is a system and method that provides powerful and unique tools for collectors ranging from novices to experts.

### FIELD OF THE INVENTION

The present invention is a system and method that provides powerful and unique tools for collectors ranging from novices to experts.

### BACKGROUND OF THE INVENTION

Collectors and enthusiasts add to and sell from their collections at local hobby shops and trade shows. By far the fastest growing trend that is growing the size of the industry is the Internet. This commercial medium has allowed collectors in different states and even different countries to interact like never before. A coin collector in Georgia can interact with one in Montana and have the ability of completing a proof set. This is all possible because of the online revolution. Even though it is likely that shows and expos will still be around for years to come it is clear that the hobby is moving online.

Collectors Universe is one of the largest sites dealing with the hobby, but it is more a conglomeration of smaller sites that relate to the hobby of collecting. The site encompasses e-commerce and basic pricing for users. This site does not allow for portfolio tracking, wireless and user reward points.

Beckett.com is a website that offers online pricing and basic e-commerce. This site specifically handles and deals with sport cards. They do not touch upon other key hobby areas mainly comics, coins and stamps.

For some time now collectors have used the Internet to add to and trade their collections. This new medium has vastly expanded the collectable market and has created a new type of collector. Unfortunately, as individuals have been able to use the Internet to add to or sell their collection they still must use old and archaic printed price guides to calculate values of individual collectables and entire collections. Often these calculations of collections are inaccurate and can take hours to compile.

U.S. Pat. No. 6,108,639 relates to a collectible conditional purchase offer management system for receiving and processing individual conditional purchase offers from buyers for one or more collectibles, such as coins, stamps, art prints, comic books, baseball cards, jewelry, or other used or secondary market goods. If a seller accepts a given conditional purchase offer, and ultimately delivers goods complying with the buyer's conditional purchase offer, the buyer is bound on behalf of the accepting seller, to form a legally binding contract.

U.S. Pat. No. 5,843,265 relates to a method and apparatus for creating a computerized market for used and collectible goods by use of a plurality of low cost posting terminals and a market maker computer in a legal framework that establishes a bailee relationship and consignment contract with a purchaser of a good at the market maker computer that allows the purchaser to change the price of the good once the purchaser has purchased the good thereby to allow the purchaser to speculate on the price of collectibles in an electronic market for used goods while assuring the safe and trusted physical possession of a good with a vetted bailee.

U.S. Pat. No. 6,085,176 relates to a method and apparatus for creating a computerized market for used and collectible goods by use of a plurality of low cost posting terminals and a market maker computer in a legal framework that establishes a bailee relationship and consignment contract with a purchaser of a good at the market maker computer that allows the purchaser to change the price of the good once the purchaser has purchased the good thereby allowing the purchaser to speculate on the price of collectibles in an electronic market for used goods while assuring the safe and trusted physical possession of a good with a vetted bailee.

### SUMMARY OF THE INVENTION

The present invention relates to a system and method, which provides a user information and services for their collectible items. It is an object of the present invention to provide features such as interactive portfolios, inter-site member notification systems, a fully integrated rewards point system, and wireless capability. The present invention provides different areas for collectors such as, “staple” areas in collecting (sports cards, comic, coins, and stamps) and also can have different categories (i.e. toys, dolls, etc.).

It is an object of the present invention to provide services such as an interactive personal inventory system (portfolio) that will give a user the current valuation of their collection at any given time and in any given place. Users can easily assign items in their portfolio to be sent to a marketplace area. Providing users with wireless capabilities through cell phones and hand held computers, members can obtain notifications that they may have a potential buyer of their items, the ability to obtain “real-time” pricing for particular items (i.e. sports cards, comics etc.), verify authenticity of autographs, and the convenience of having a “want list” of items.

The present invention is setup to accommodate both dealers and hobby collectors a like in a community based setting. The present invention provides a system with a variety of mainstream collectable areas being addressed, including: Sport Cards, Memorabilia, Stamps, Coins and Comics. Besides covering the “staple” collectable areas, the site is also setup to attend to the “Hot” hobby trends that come and go rather quickly. The present invention provides reliable and precise information, as well as specialty services, with the ability to extend to wireless. It is an object of the present invention to provide a place where collectors gather online to maintain, expand, and market their individual collections. The Collector can monitor, track and profit from their collection.

It is an object of the present invention to provide a collectibles themed portal that provides a collector with interactive tools to manage and exploit their collection. As a portal, the present invention creates a community filled with news, calendar events, message board areas, an authenticity of autographs section, real-time quotes, “hot list” reports, and powerful search engine capability for collectors, both novice and expert, in most areas of collecting.

In addition, it is an object of the present invention to incorporate a reward point system that allows users to acquire points while on the site to later redeem them for discounts, free merchandise, and giveaway entries.

It is an object of the present invention to provide a website complete with various templates to customize and create their site. This will result in a user's “virtual” storefront all delivered and powered through the present invention. Using templates supplied by the present invention, users can create a “virtual storefront” displaying items they have for sale. This concept is geared more toward “dealer” type collectors that own small “bricks and mortar” stores, but do not have the ability to get their business onto the Internet.

From the portfolio, users can enter items, obtain automatic values for those items, and tag specific items in their collection portfolio to be sent to the market place. Since the present invention provides automatic pricing, users only have to implement their collections once and reap the benefits of always knowing the monetary value. It is an object of the present invention to update valuations of items systematically, but preferably monthly as is standard in the industry. The collector has the ability to tag a number of items out of their portfolio to be sent to an area for perspective buyers to view, known as the marketplace. In an embodiment, if a user has sent an item to the marketplace, and there is someone interested in purchasing it, a message will appear in the member's portfolio area.

It is then up to the potential buyer and seller to work out the transaction. Since the hobby and business of collecting does deal with trends, the present invention also provides a fantasy portfolio. This area is intended for user to track certain items that they may want in the future. Tracking trends will never be easier since the present invention also includes automatic pricing in the fantasy portfolio. If a user obtains an item in their fantasy portfolio, they can easily send that item to their real portfolio, reducing double entry work.

Keeping in mind that collectors go to trade shows, retail stores, and even garage sales in search of items, it is an object of the present invention to provide a wireless solution. It is an object of the present invention to integrate wireless technology for most of the above mentioned tools/services. From any hand held computer, PDA device, or wireless phone, a user can obtain real time pricing information from the present site. Furthermore, a user can access want lists, autograph verifications, and retrieve messages from a user's inbox.

It is an object of the present invention to match a potential buyer with an item they truly are looking for, thus paving the way for a search engine to do just that.

It is an object of the present invention to design a reward point system that allows users to accumulate points as they enter items into their portfolios, purchase items from the marketplace, and navigate around the site. The points are then redeemable for discounts for certain services, exchangeable for promotional items, and enters users into various drawings for prizes.

It is an object of the present invention to provide news, calendar events, message boards/live chat capability, member profile abilities, and a member rating system.

The present invention features online real-time pricing and tracking. With the wireless integration, users will have the ability of tracking collections anytime and anywhere. The present invention matches collectors in its collectable community and allows for individual deals to occur. The present invention is an online tool for the collector to utilize in maintaining, building and selling individual collections.

The present invention gives a collector the ability of finding a collection value in a matter of seconds. The present invention allows users the ability to buy or sell as well as access thousands of collectables that are offered through registered users of the present invention. Other features of the present invention bring anytime and anywhere wireless abilities to users. This allows registered users access to pricing on their collections anywhere using the most popular PDA devices.

### BRIEF DESCRIPTION OF THE DRAWINGS

FIG. 1 illustrates an example of a screen shot of a personal portfolio.

FIG. 2 illustrates an example of a screen shot of a personal portfolio, specifically showing the types of grades.

FIG. 3 illustrates an example of a screen shot of a personal portfolio, specifically showing the year.

FIG. 4 illustrates an example of a screen shot of a personal portfolio, specifically showing the manufacturer.

### DETAILED DESCRIPTION OF THE INVENTION

In one embodiment of the present invention, a user can input their portfolio of collectible items. The system will give the user a price valuation. In a preferred embodiment the system automatically updates the pricing for the user systematically.

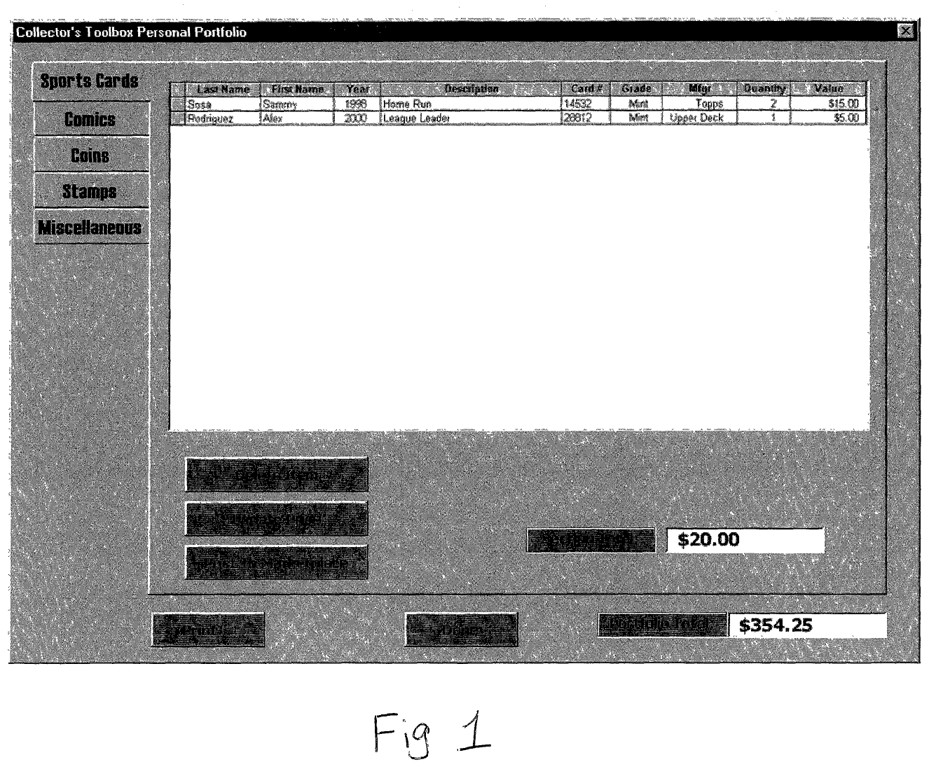

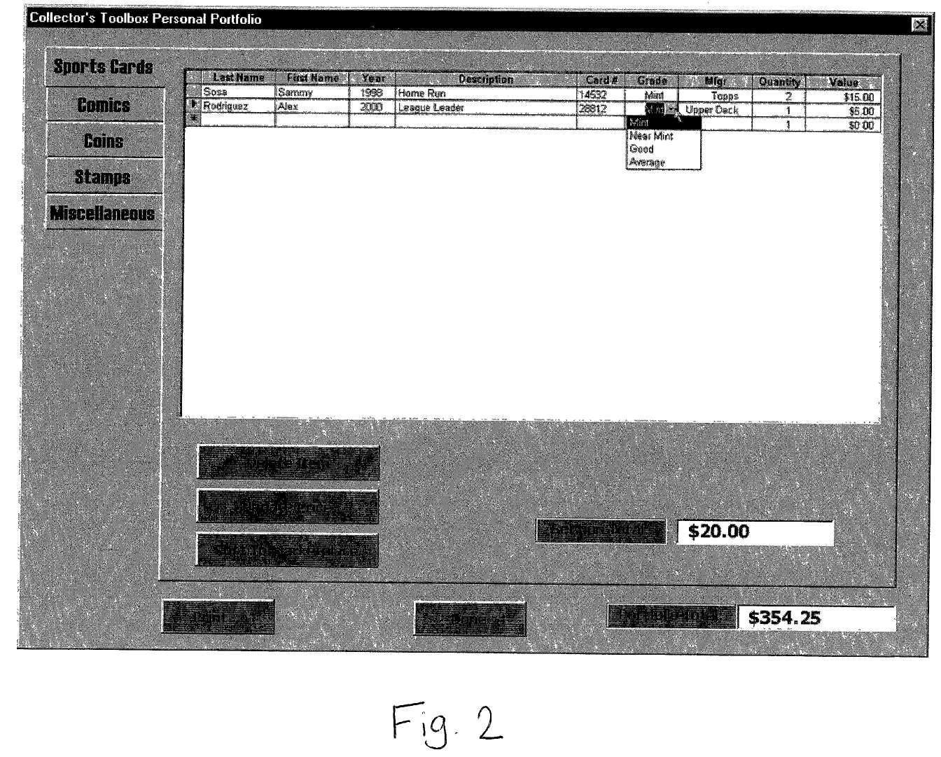

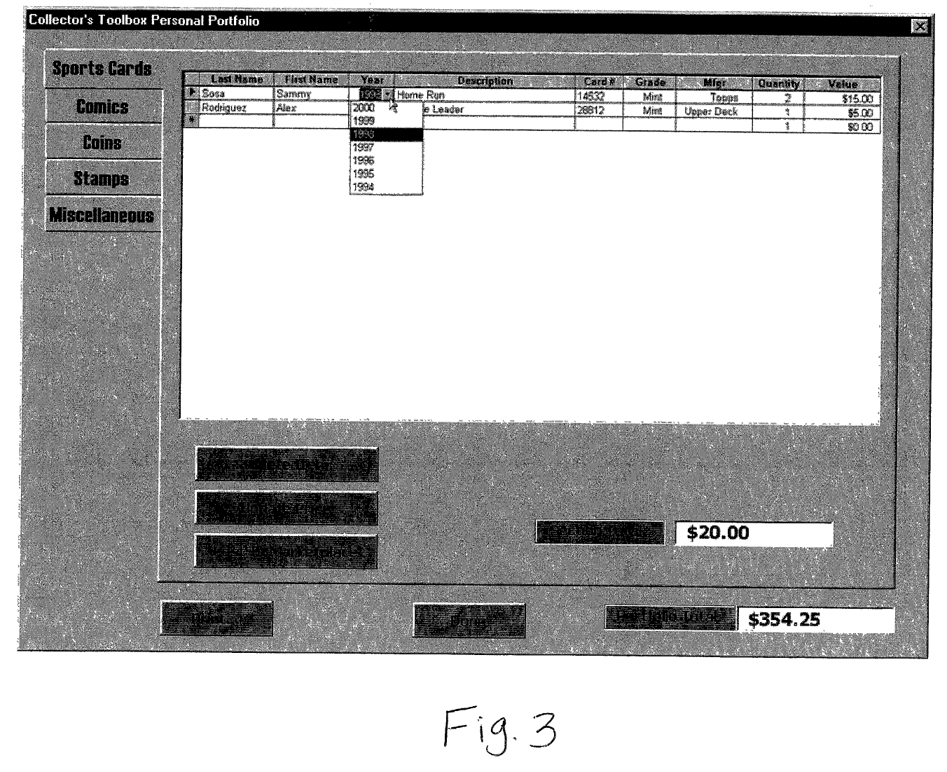

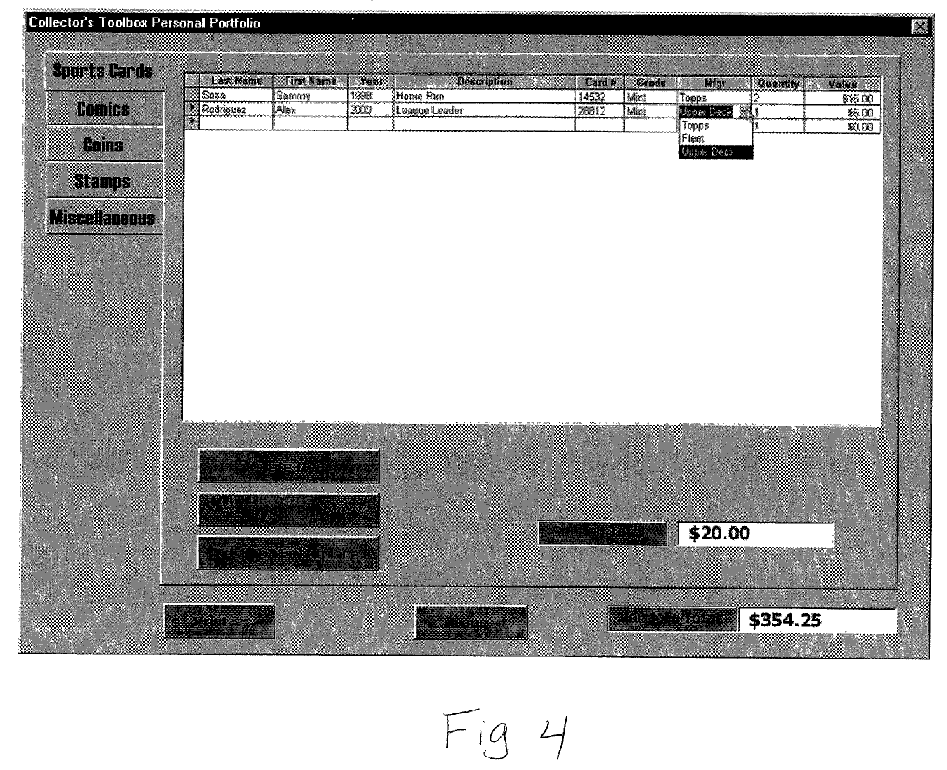

FIG. 1 illustrates a personal portfolio of the present invention. FIG. 1 illustrates an example of a sports cards personal portfolio. A user inputs, the last name and first name of the player on the Sports Card. The user inputs the year of the Sports Card or can click on the year as shown in FIG. 3. FIG. 1 further has a description category for describing the type of sports card and a Card # category. FIG. 2 illustrates the grade category which can be inputted or selected from categories such as Mint, Near Mint, Good and Average. FIG. 4 illustrates the manufacturer of the Sports Card category. FIG. 1 further has categories for Quantity and value of the Sports Card. FIG. 1 shows features such as deleting an item from the portfolio. FIG. 1 shows the Section Total which adds the value of the Cards shown on the screen. FIG. 1 further shows the personal portfolio total of a user. FIG. 1 illustrates the update price feature which can update the portfolio price of a user. FIG. 1 further illustrates the post to marketplace feature, which allows a user to attempt to sell a sports card.

In a preferred embodiment, the more one navigates around the site, the more reward points a user earns.

In a preferred embodiment, the system has a Fantasy type portfolio. This area is intended for a user to track certain items that they may want to add their collection in the future. The system tracks pricing trends, and includes automatic price updates. A user that obtains an item in the fantasy portfolio can easily send that item to their real portfolio reducing double entry work.

In a preferred embodiment, the system has an Authenticity area. This area is intended to research and get relevant and detailed information on the authenticity of certain items. It serves as a reference to educate users. This section contains an interactive and online library of sample authentic signatures that can be used as a reference point. This section contains forgeries and fake signatures also on file.

Search capability—In a preferred embodiment the system of the present invention can search a Sports Card by year, make, manufacturer, card number, and name.

In one embodiment, the main navigation will be file format/tab based. Users will query the service/product database based upon “Collection” categories. These categories will be accessible on every shopping page via a series of file format menus located throughout the site.

A “Keyword” search text field will be accessible to users to query the database as well as the entire site. The user will have a choice of search options based upon the section of the site the search takes place. This keyword search field will be present wherever the “Collection” navigation appears. A user will enter a “keyword” into the search field. A Boolean search can take place on pre-defined fields in the database.

In a preferred embodiment, the Boolean search for a Sports Card can query the product fields as follows:

Category

Description

Year

Manufacturer

Title

Player

A user will have the ability to check status of rewards points and pending orders as well as past order history.

A user will have the ability to see the utilization statistics of their portfolio. Statistics will be based on usage such as, Items currently in portfolio, Items in Marketplace, Empty Marketplace Spots.

The Your Account section of the system allows a user to view their account status, Rewards Points, Billing information, Portfolio status, CT mail and current or past order.

The user will also have the ability to update their Profile and Portfolio from the Your Account area.

Quick Quote

A user can request a “Quick Quote”, for example with Sports Cards, based upon the following fields: Name, manufacturer, Year, and Grade. The Quick Quote system will return all relevant results with pricing. The Quick Quote System will query the entire CT price guide database to return a quote. In a preferred embodiment, the Quick Quote search is in the “Closet Match” format for some fields and pull-down menu for others. For searches across multiple categories there is an option to search only in a specific Collection Category should the user request it.

A tie in module allows an “Autograph on File” icon to be displayed in the “Quick Quote” system when a quote is returned that matches a signature on file in the “Authentication” database.

A WIRELESS version of “Quick Quote” is also available to users.

Rewards Engine

The rewards engine allows a user to accumulate “Points” for performing certain actions. Points can be assigned to specific actions by entering a string of code within objects. Points are accumulated at a “MAX PER DAY” rate.

Points are used toward purchase of CT goods and services. In an embodiment, points have “ZERO” dollar value. Points are also accumulated for random drawings at pre-determined intervals. Point status is displayed to a logged in user dynamically at all times throughout the site.

The present invention allows a user to choose products based on main categories. When a main category is chosen, the viewer will have the choice of sub categories. Once a sub category is chosen the system will display products for that sub category.

In a preferred embodiment, each product has a “BUY” button. When the “BUY” button is clicked the product will be added to the Shopping Cart. In the shopping cart area, the options available are 1. Shop for more 2. Adjust quantity 3. Apply Changes 4. Checkout. When a user clicks “Shop For More” the system will bring them back to the last category they were viewing.

In a preferred embodiment, if the user is already a registered member of the site the user is prompted to enter their e-mail address (logon) and their password. At final checkout the system auto populates the bill and ship to addresses from the data in the member's profile. The member will have the option of changing those addresses.

In a preferred embodiment, shipping is automatically calculated using real time by sending the product weight, CT origination zip code and the member's destination zip code to a UPS (United Parcel Service) database. The UPS database will return exact shipping amounts for the member to view.

Points used for this purchase are displayed or if the user does not have sufficient points for the purchase they are prompted to distribute points differently among the items in their cart or delete items. This shopping engine runs purely on a “points for product” basis. The user may view update point status in the “Membership Profile” section. New point status is also displayed in static window throughout the site.

Authentication

In a preferred embodiment, the present invention provides an “Authentication” system which provides “Signature Authentication” services to users. A user can choose from a set of fields to find the signature of the player, author, artist etc. In an embodiment, signatures are displayed as low-resolution black and white GIF files.

A tie in module allows an “Autograph on File” icon to be displayed in the “A Quick Quote” system when a quote is returned that matches a signature on file. In a preferred embodiment, the system of the present invention has a WIRELESS interface.

My Portfolio

The My Portfolio System allows the Posting, Viewing, Updating and Procurement of portfolio items. A “My Portfolio” icon is available to all logged in users at all times. All users can create portfolios among all of the collection categories.

In an embodiment, My Portfolio will view in File Format with tab navigation breaking across all collection categories. The present invention provides a wireless access for users (text only version of portfolio).

Entering Portfolio Items

In an embodiment of the present invention, portfolio items can be entered by a user using a web browser (4.0 or higher) through their portfolio administration system. Options for adding and deleting items as well as links to change plans are available in the administration area. Users can enter items into pre-determined fields or use a search tool tied into the CT quote database to auto populate item fields.

Real time pricing for items is available to users entering items pulled from the CT quote database. The user can enter non real-time pricing for items not found in the CT quote database.

In a preferred embodiment, the user can upload pictures of each item. Images conform to the following specifications: GIF or JPEG format, image size no larger than 350×350 pixels. Users can mark set amount of items for “Market-Place” viewing by other members.

Viewing Portfolio Items

In an embodiment of the present invention, portfolio items can be viewed with two options, “Text Only” and “Text with Thumbnail Image”. Thumbnail size is approximately 66×80. Images are auto formatted to correct thumbnail size from original uploaded image. Users can sort portfolio items alphabetically, by year or manufacturer. Thumbnail images can open to full size image.

Portfolio Fields

The following is an example of fields that are entered by the user when posting items in the portfolio.

Sports Cards:

Year of card-Manufacturer-Card #-Last name-First name-Grade-Serial number-Quantity-Image-Add to Marketplace (button)

Comics

Title-Date of issue-Issue number-Publisher-Quantity-Grade-Serial number-Add to Marketplace (button)

Stamps

Country-Denomination-Postmarked (Yes or No)-Scott number-Grade-Serial number-Quantity-Image-Add to Marketplace (button)

Coins

Denomination-Type/Series-Date-mintmark-Grade-Serial number-Country-Quantity-Image-Add to Marketplace (button) Market-Place

The “Market-Place” allows a user to view collectables for sale by other members. A member can search using the Market-Place search engine or browse all by collection category. A total number of items are visible next to each main collection category.

In an embodiment, items can be viewable based on Market-Place fields listed below. In an embodiment, users view items TEXT ONLY at first. Once an item is clicked on, the user can see full details about the item and view full size image. Communication tools are available for users to communicate with the seller.

Market-Place Fields

When a user wants to enter items into the “Market Place” they can click the “add to “Market-Place” button next to the portfolio item they want to add to the “Market-Place”. Below, is an example of fields which are populated for the pre-posted item.

Sports cards

Year of card (this should be defaulted to what is in the portfolio entry)

Manufacturer (this should be defaulted to what is in the portfolio entry)

Card # (this should be defaulted to what is in the portfolio entry)

Players Name (this should be defaulted to what is in the portfolio entry)

Grade (this should be defaulted to what is in the portfolio entry)

Quantity (this should be defaulted to what is in the portfolio entry)

Price—dollar amount user wants to charge for this card

Picture—if not already uploaded

Description—the ability to describe aspects of the item for sale.

Payment Method accepted

Shipping Costs and or Method of calculation

Comics

Year of issue (this should be defaulted to what is in the portfolio entry)

Publisher (this should be defaulted to what is in the portfolio entry)

Issue # (this should be defaulted to what is in the portfolio entry)

Title (this should be defaulted to what is in the portfolio entry)

Grade (this should be defaulted to what is in the portfolio entry)

Quantity (this should be defaulted to what is in the portfolio entry)

Price—dollar amount user wants to charge for this comic

Picture—if not already uploaded

Description—the ability to describe aspects of the item for sale.

Payment Method accepted

Shipping Costs or method of calculation

Stamps

Country (this should be defaulted to what is in the portfolio entry)

Denomination (this should be defaulted to what is in the portfolio entry)

Postmarked (Yes/No) (this should be defaulted to what is in the portfolio entry)

Scott Number (this should be defaulted to what is in the portfolio entry) Grade (this should be defaulted to what is in the portfolio entry)

Quantity (this should be defaulted to what is in the portfolio entry)

Price—dollar amount user wants to charge for this stamp

Picture—if not already uploaded

Description—the ability to describe aspects of the item for sale.

Payment Method accepted

Shipping Costs or method of calculation

Coins

Denomination (this should be defaulted to what is in the portfolio entry)

Type/Series (this should be defaulted to what is in the portfolio entry)

Date—Mintmark (this should be defaulted to what is in the portfolio entry)

Country (this should be defaulted to what is in the portfolio entry)

Grade (this should be defaulted to what is in the portfolio entry)

Coin Type (this should be defaulted to what is in the portfolio entry)

Quantity (this should be defaulted to what is in the portfolio entry)

Price—dollar amount user wants to charge for this coin

Picture—if not already uploaded

Description—the ability to describe aspects of the item for sale.

Payment Method accepted

Shipping Costs or calculation method

Market-Place Search Engine

The Market-Place search engine allows a user to search ONLY in the Market Place. The user can search among any of the collection categories. Below, is a list of examples:

Sports cards:

Year of card, Manufacturer, Card #, Last Name, First Name, Grade

Comics:

Title, Date of issue, Issue number, Publisher, Grade

Stamps:

Country, Denomination, Postmarked (Yes/No), Scott Number, Grade

Coins:

Denomination, Type/Series, Date-Mintmark, Grade, Country

Search Engine Display Results

In a preferred embodiment, after a buyer has filled in their search criteria, the results can be laid out as follows, in hyperlink form: (assuming the buyer takes the default sort criteria)

Sports cards:

| Year of card | Manufacturer Card # | Last Name | First Name | Grade |
|---|---|---|---|---|
| Comics: | | | | |
| Title | Date of issue | Issue number | Publisher | Grade |
| Stamps: | | | | |
| Country | Denomination | Postmarked (Yes/No) | Scott Number | Grade |
| Coins: | | | | |
| Denomination | Type/Series | Date-Mintmark | Grade Country | |

Databases

In a preferred embodiment, the database of the present invention will store all of the user information such as, profiles and order history.

Transactional Database: This database stores all of the transactional data for the system such as, rewards points, portfolios, data cleansing application, marketplace, quote database.

Entering New Product

In an embodiment of the present invention, when entering a new product the following fields will be available to the administrator: Item Name, Brand, Description, Image, Points to Purchase, Size, Color, Shipping Weight.

1. A system for collectible items comprising:
a database;
an interactive portfolio;
a search engine;
inter-site member notification.

2. The system of claim 1 further comprising:
a rewards point system.

3. The system of claim 1 further comprising:
wireless capability.

4. The system of claim 1 wherein said collectible items are selected from the group comprising sports cards, comics, coins, or stamps.

5. The system of claim 1 wherein said interactive portfolio provides a user with current valuation of said collectible items.

6. The system of claim 1 further comprising real-time pricing.

7. The system of claim 1 further comprising:
a database for authenticating autographs.

8. The system of claim 1 further comprising:
a database consisting of a user's want list items.

9. The system of claim 1 wherein a user can place said collectible items for sale and said system notifies said user when a buyer is interested.

10. The system of claim 1 further comprising:
a fantasy portfolio.

11. The system of claim 2 wherein said rewards point system allows a user to accumulate points for entering items in a portfolio, purchasing items or navigating in said system.

12. The system of claim 5 wherein said interactive portfolio provides said user with systematic updates of values of said collectible items.

13. The system of claim 2 wherein said user can check status of rewards points pending orders and past order history.
